(19) United States
(12) Patent Application Publication
(10) Pub. No.: US 2026/0360095 A1
(43) Pub. Date: Nov. 12, 2026

(54) WEARABLE DEVICE AS A MEDIA DISPLAY FOR IMMERSIVE CONTENT

(71) Applicant: Apple Inc., Cupertino, CA (US)

(72) Inventors: Luis R. DELIZ CENTENO, Fremont, CA (US); Joshua J. FROST, Aptos, CA (US); Rahul NAIR, Hayward, CA (US); Devin W. CHALMERS, Oakland, CA (US)

(21) Appl. No.: 19/668,743

(22) Filed: May 5, 2026

Related U.S. Application Data
(60) Provisional application No. 63/804,511, filed on May 12, 2025.

(51) Int. Cl. G06T 19/00; G06F 3/01; G06F 3/04815

(52) U.S. Cl. CPC G06T 19/006; G06F 3/013; G06F 3/04815

(57) ABSTRACT

In some examples, a wearable device is in communication with one or more displays and one or more input devices to present a three-dimensional environment to a user. In some examples, the three-dimensional environment includes a second electronic device with a display that is communicatively coupled to the wearable device. In some examples, the wearable device detects content displayed on the second electronic device's display via the one or more input devices. In some examples, upon determining that the displayed content satisfies one or more predefined criteria, the wearable device presents a first set of features associated with the content within the three-dimensional environment at a location distinct from the second electronic device's display. In some examples, the second electronic device's display concurrently presents a second set of features associated with the content, different than the first set of features.

### CROSS-REFERENCE TO RELATED APPLICATIONS

This application claims the benefit of U.S. Provisional Application No. 63/804,511, filed May 12, 2025, the contents of which are incorporated herein by reference in their entirety for all purposes.

### FIELD OF THE DISCLOSURE

This disclosure relates generally to a wearable device, and more particularly, to a head-mounted wearable device including one or more displays in communication with a secondary electronic device configured to transmit spatial content to be displayed at the head-mounted wearable device.

### BACKGROUND OF THE DISCLOSURE

Some computer graphical environments provide two-dimensional (2D) and/or three-dimensional (3D) environments where at least some objects displayed for a user's viewing are virtual and generated by a computer. In some examples, a user may interact with these virtual objects in real time.

### SUMMARY OF THE DISCLOSURE

This disclosure generally relates to a method for enhancing user interaction with content by presenting content-related features across multiple displays including a display that presents a three-dimensional environment. A wearable device, such as a head-mounted wearable device, in communication with one or more displays and one or more input devices, presents a three-dimensional environment that includes an electronic device with a display. The wearable device detects content displayed on the electronic device and determines whether the content satisfies one or more criteria (e.g., predefined). Upon satisfying the one or more criteria, the wearable device presents a first set of features associated with the content at a different location within the three-dimensional environment, separate from the electronic device's display. Additionally, the electronic device at least partially simultaneously displays a second set of features, different from the first set, on the display of the electronic device. By distributing the respective set of features across spatially separate display regions within the three-dimensional environment, the system reduces visual obstruction of the content displayed on the electronic device while maintaining access to associated controls, thereby improving visibility and usability of the content. Furthermore, presenting the first set of features at a spatial location separate from the electronic device display reduces the number of interface elements that must be rendered on the electronic device display, thereby reducing interface clutter and improving utilization of the display area for presentation of the primary content. This approach enables improved visualization and user interaction with virtual content, intelligently leveraging spatial distribution across multiple display surfaces within a three-dimensional environment.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the scope of the disclosure.

### BRIEF DESCRIPTION OF THE DRAWINGS

For a better understanding of the various described examples, reference should be made to the Detailed Description below, in conjunction with the following drawings in which like reference numerals refer to the corresponding parts throughout the figures.

FIG. 1 illustrates an electronic device presenting a three-dimensional environment according to some examples of the disclosure.

FIGS. 2A-2B illustrate block diagrams of example architectures for electronic devices according to some examples of the disclosure.

FIG. 3A illustrates a three-dimensional environment presented by a wearable device that includes a second electronic device with a display in communication with the wearable device according to some examples of the disclosure.

FIG. 3B illustrates the wearable device presenting spatial content in the three-dimensional environment in response to a user input according to some examples of the disclosure.

FIG. 3C illustrates an alternative example of the wearable device presenting the spatial content in the three-dimensional environment in response to a gaze input according to some examples of the disclosure.

FIG. 3D illustrates the wearable device maintaining the presentation of the spatial content at a location in the three-dimensional environment while a user moves in the three-dimensional environment according to some examples of the disclosure.

FIG. 3E illustrates the second electronic device displaying content that includes the spatial content at the display of the second electronic device in response to a detection of the gaze input by the wearable device according to some examples of the disclosure.

FIG. 3F illustrates the wearable device presenting a modification of one or more aspects of the spatial content in the three-dimensional environment according to some examples of the disclosure.

FIG. 3G illustrates an alternative example of the wearable device presenting the modification of the spatial content in the three-dimensional environment that includes a presentation of one or more controls in the three-dimensional environment according to some examples of the disclosure.

FIG. 3H illustrates the wearable device perceiving a lowering of a brightness of the display of the second electronic device while displaying the spatial content in the three-dimensional environment according to some examples of the disclosure.

FIG. 3I illustrates the wearable device increasing the brightness of the display of the second electronic device while displaying the spatial content in the three-dimensional environment according to some examples of the disclosure.

FIG. 3J illustrates the electronic device displaying a photo gallery while the user provides a user input at the second electronic device according to some examples of the disclosure.

FIG. 3K illustrates the wearable device displaying a spatial photo in the three-dimensional environment in response to the user input provided at the second electronic device according to some examples of the disclosure.

FIG. 3L illustrates the wearable device updating the display of the spatial photo in the three-dimensional environment in response to the user input directed at the spatial photo according to some examples of the disclosure.

FIG. 4 illustrates an example method of displaying spatial content within the three-dimensional environment according to some examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used, and structural changes can be made without departing from the scope of the disclosed examples.

This disclosure generally relates to a method for enhancing user interaction with content by presenting content-related features across multiple displays including a display that presents a three-dimensional environment. A wearable device, such as a head-mounted wearable device, in communication with one or more displays and one or more input devices, presents a three-dimensional environment that includes an electronic device with a display. The wearable device detects content displayed on the electronic device and determines whether the content satisfies one or more criteria (e.g., predefined). Upon satisfying the one or more criteria, the wearable device presents a first set of features associated with the content at a different location within the three-dimensional environment, separate from the electronic device's display. Additionally, the electronic device at least partially simultaneously displays, a second set of features, different from the first set, on the display of the electronic device. By distributing the respective set of features across spatially separate display regions within the three-dimensional environment, the system reduces visual obstruction of the content displayed on the electronic device while maintaining access to associated controls, thereby improving visibility and usability of the content. Furthermore, presenting the first set of features at a spatial location separate from the electronic device display reduces the number of interface elements that must be rendered on the electronic device display, thereby reducing interface clutter and improving utilization of the display area for presentation of the primary content. This approach enables improved visualization and user interaction with virtual content, intelligently leveraging spatial distribution across multiple display surfaces within a three-dimensional environment.

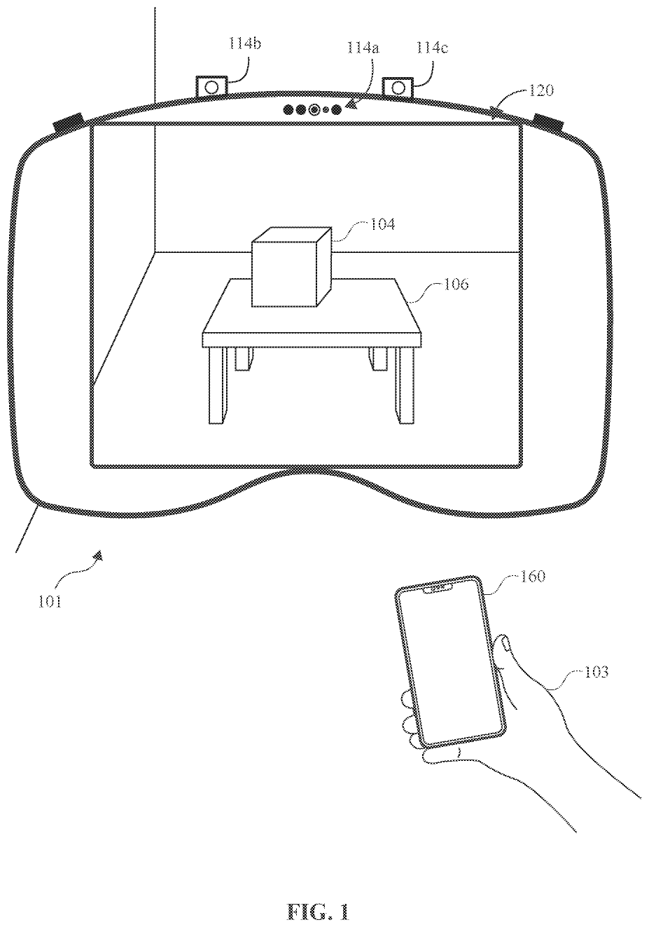

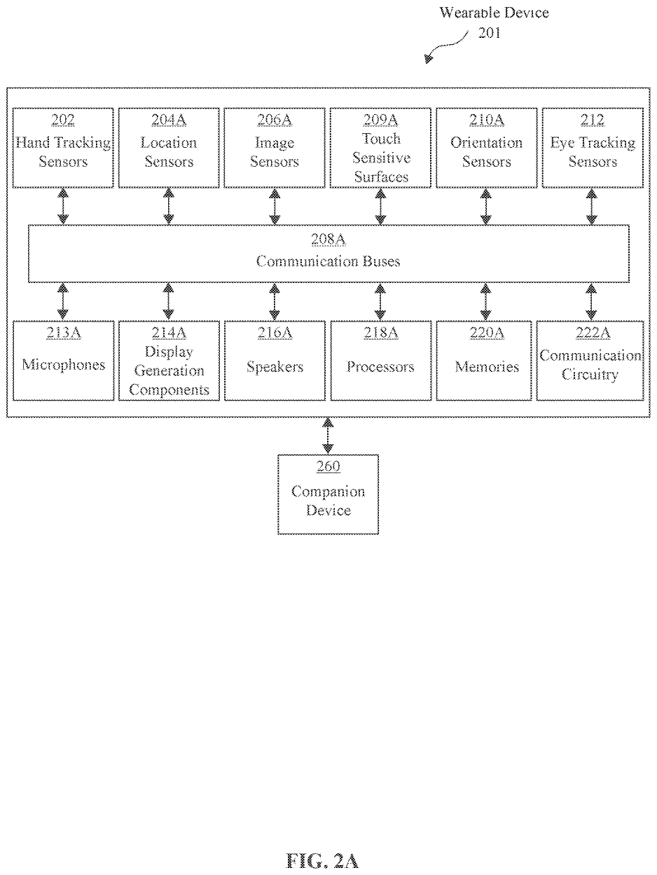

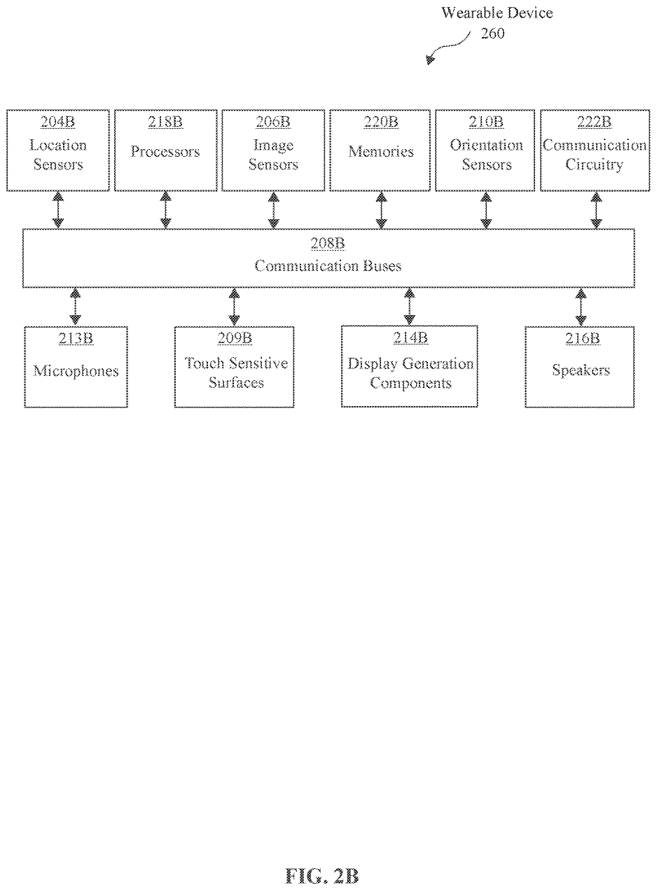

FIG. 1 illustrates a wearable device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, wearable device 101 is a head-mounted display or other head-mountable device configured to be worn on a head of a user of the wearable device 101. Examples of wearable device 101 are described below with reference to the architecture block diagram of FIG. 2A. As shown in FIG. 1, wearable device 101 and table 106 are located in a physical environment. The physical environment may include physical features such as a physical surface (e.g., floor, walls) or a physical object (e.g., table, lamp, etc.). In some examples, wearable device 101 may be configured to detect and/or capture images of the physical environment including table 106 (illustrated in the field of view of wearable device 101).

In some examples, as shown in FIG. 1, wearable device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, wearable device 101 also includes external image sensors 114b and 114c facing outwards from the user to detect and/or capture the physical environment of the wearable device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, wearable device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and present the virtual object 104) and alternatively presents a direct view of the physical environment in the user's field of view (e.g., the field of view of the user's eyes).

In some examples, the wearable device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the wearable device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of wearable device 101 and interpreted as one or more user inputs directed to content displayed by wearable device 101. Additionally or alternatively, in some examples, the one or more user inputs interpreted by the wearable device 101 as being directed to content displayed by wearable device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the wearable device 101 may be configured to communicate with a second electronic device, such as a companion device. For example, as illustrated in FIG. 1, the wearable device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the wearable device 101 and the electronic device 160 are associated with a same user. For example, in FIG. 1, the wearable device 101 may be positioned on (e.g., mounted to) a head of a user and the electronic device 160 may be positioned near wearable device 101, such as in a hand 103 of the user (e.g., the hand 103 is holding the electronic device 160), a pocket or bag of the user, or a surface near the user. The wearable device 101 and the electronic device 160 are optionally associated with a same user account of the user (e.g., the user is logged into the user account on the wearable device 101 and the electronic device 160). Additional details regarding the communication between the wearable device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, wearable device 201 and/or electronic device 260 include one or more electronic devices. For example, the wearable device 201 may be a portable device, an auxiliary device in communication with another device, a head-mounted display, a head-worn speaker, etc., respectively. In some examples, wearable device 201 corresponds to wearable device 101 described above with reference to FIG. 1. In some examples, electronic device 260 corresponds to electronic device 160 described above with reference to FIG. 1.

As illustrated in FIG. 2A, the wearable device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The wearable device 201 optionally includes one or more output devices, such as one or more display generation components 214A, optionally corresponding to display 120 in FIG. 1, one or more speakers 216A, one or more haptic output devices (not shown), etc. The wearable device 201 optionally includes one or more processors 218A, one or more memories 220A, and/or communication circuitry 222A. One or more communication buses 208A are optionally used for communication between the above-mentioned components of wearable device 201.

Additionally, the electronic device 260 optionally includes the same or similar components as the wearable device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the wearable device 201. For example, in some examples, the electronic device 260 processes sensor inputs from electronic devices 201 and 260 and/or generates content for display using display generation components 214A of wearable device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the one or more display generation components 214A and/or 214B are in communication with the electronic device either by virtue of being a part device, or by being connected to the electronic device through wired or wireless communication mediums. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the wearable device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the wearable device 201 (and/or electronic device 260), but are not integrated with the wearable device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from wearable device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the wearable device 201, 260, but are not integrated with the wearable device 201, 260 (e.g., within a housing of the wearable device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, wearable device 201 or electronic device 260 corresponds to a head-worn speaker (e.g., headphones or earbuds). In such instances, the wearable device 201 or the electronic device 260 is equipped with a subset of the other components illustrated in FIGS. 2A and 2B and described herein. In some such examples, the wearable device 201 or the electronic device 260 is equipped with one or more image sensors 206A, 206B, the one or more motion and/or orientations sensors 210A, 210B, and/or speakers 216A, 216B.

In some examples, wearable device 201, 260 uses CCD sensors, event cameras, and depth sensors in combination to detect the physical environment around wearable device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, wearable device 201, 260 uses the one or more image sensors 206A, 206B to detect the position and orientation of wearable device 201, 260 and/or the one or more display generation components 214A, 214B in the real-world environment. For example, wearable device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Wearable device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of wearable device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows wearable device 201, 260 to determine the absolute position of the electronic device in the physical world.

Electronic devices 201 and 260 include one or more orientation sensors 210A and 210B, respectively, for detecting orientation and/or movement of wearable device 201 and/or the one or more display generation components 214A and orientation and/or movement of electronic device 260 and/or the one or more display generation components 214B, respectively. For example, wearable device 201, 260 uses the one or more orientation sensors 210A, 210B to track changes in the position and/or orientation of wearable device 201, 260 and/or the one or more display generation components 214A, 214B, such as with respect to physical objects in the real-world environment. The one or more orientation sensors 210A, 210B optionally include one or more gyroscopes and/or one or more accelerometers.

In some examples, the wearable device 201 includes one or more hand tracking sensors 202 and/or one or more eye tracking sensors 212, discussed in further detail below. It is understood, that although referred to as hand tracking or eye tracking sensors, that wearable device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, wearable device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the wearable device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the wearable device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, wearable device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using wearable device 201 and/or electronic device 260, is optionally referred to herein as a user or users of the device.

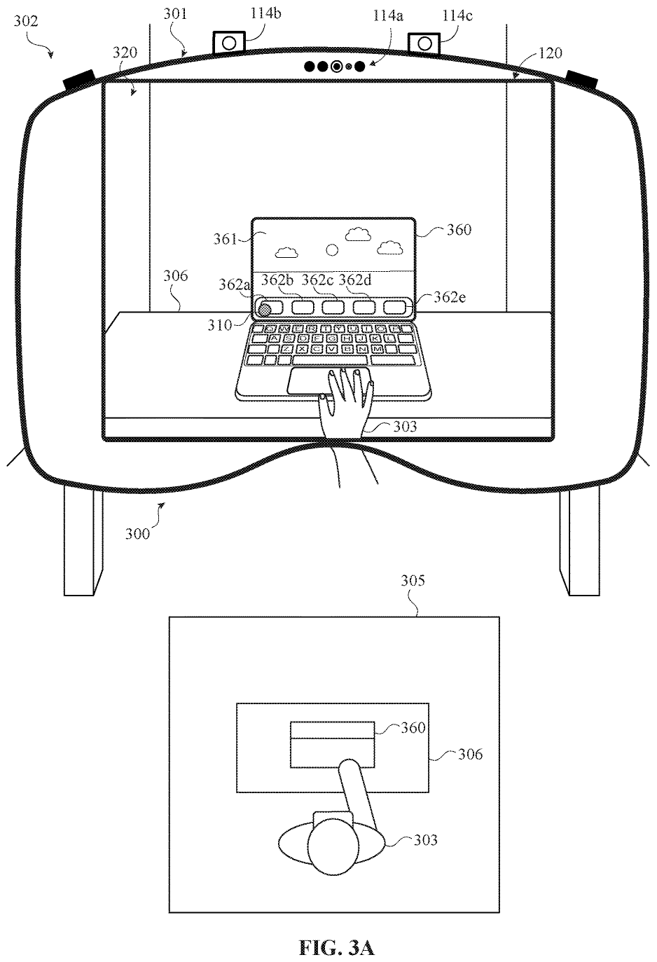

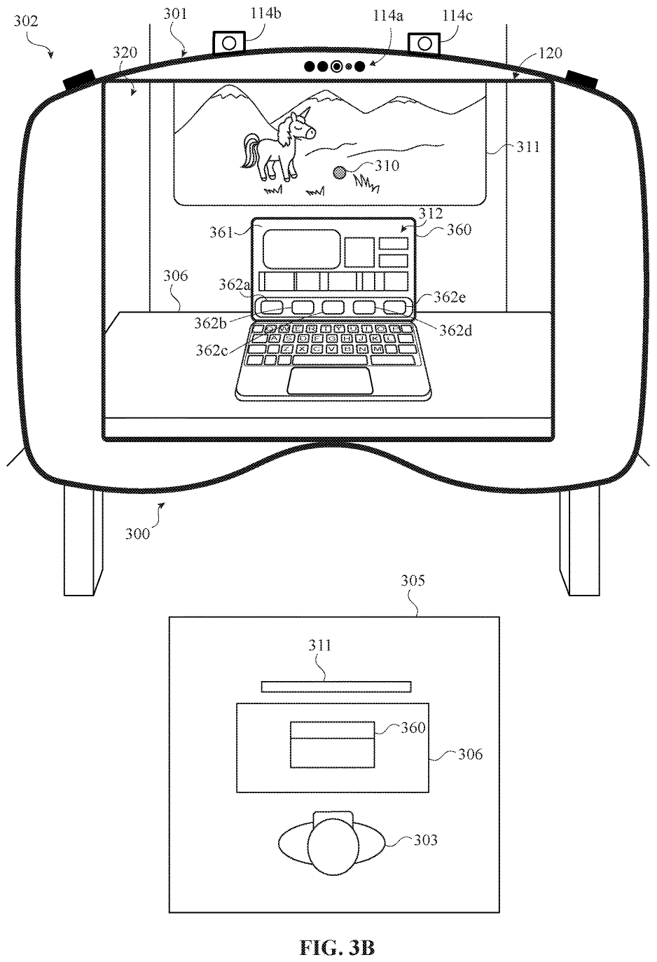

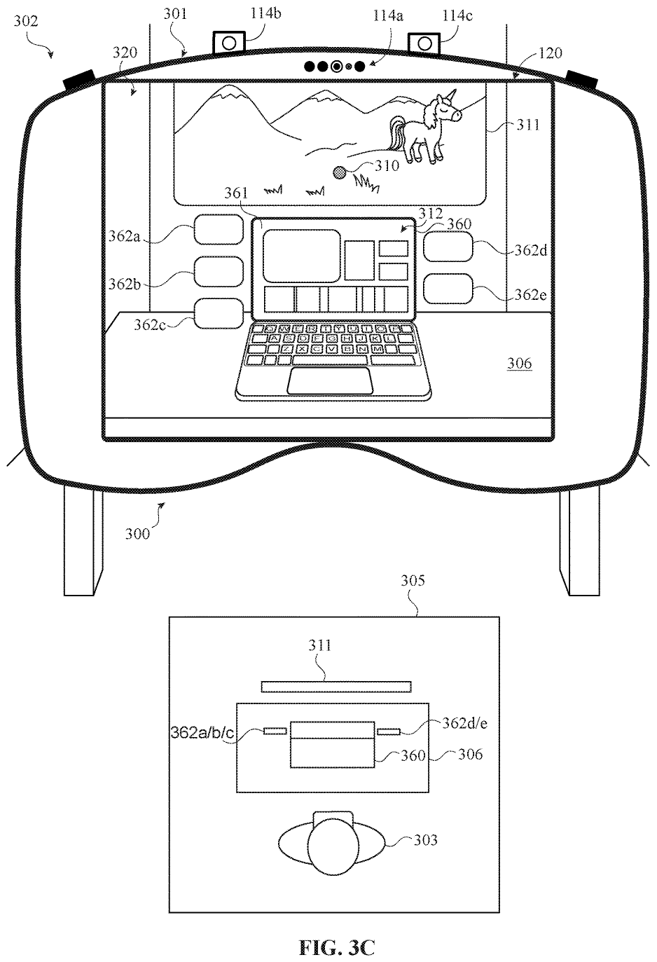

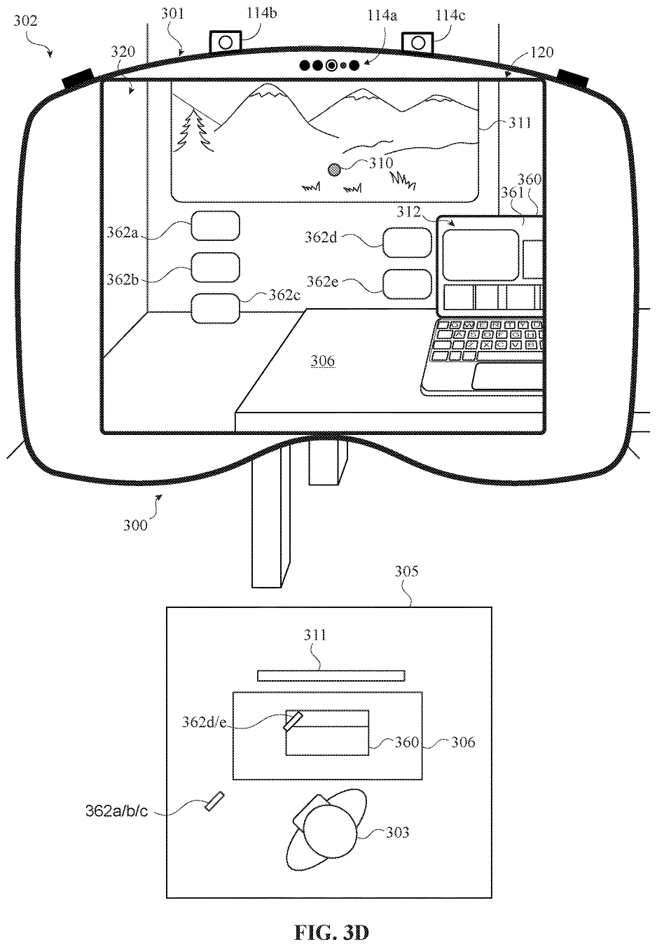

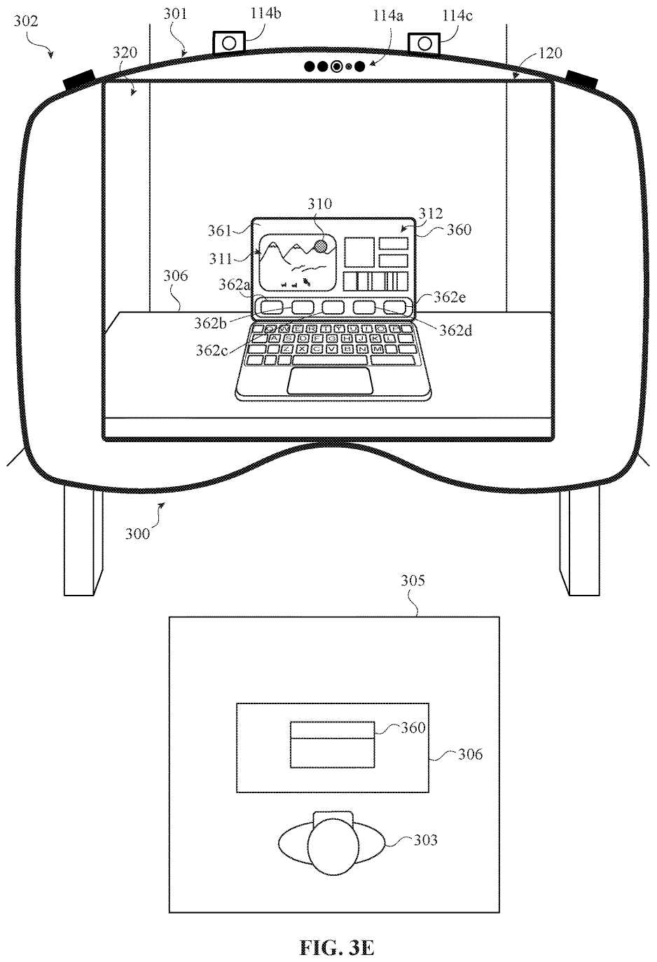

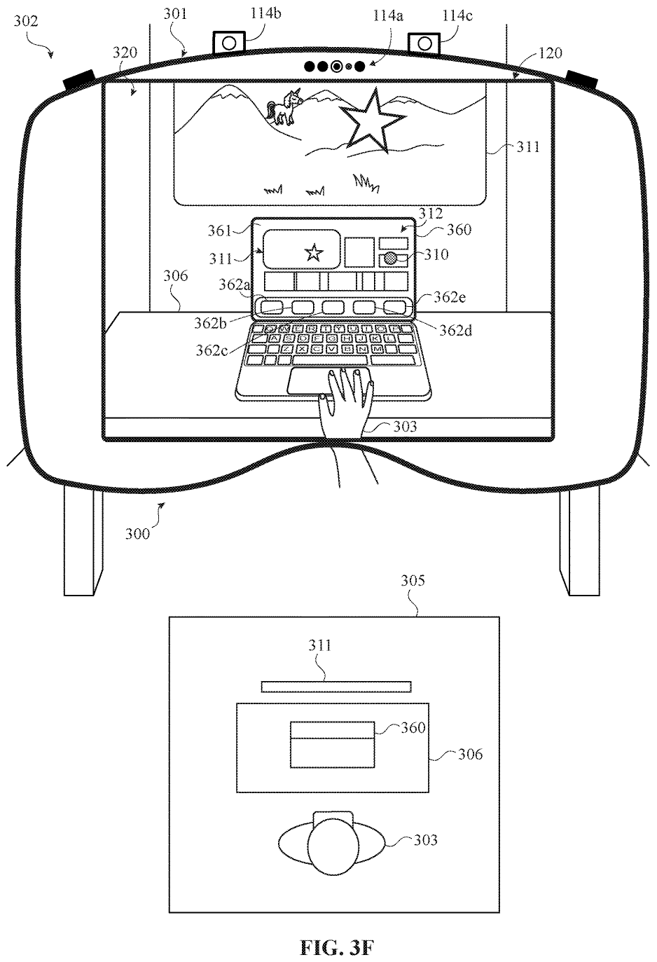

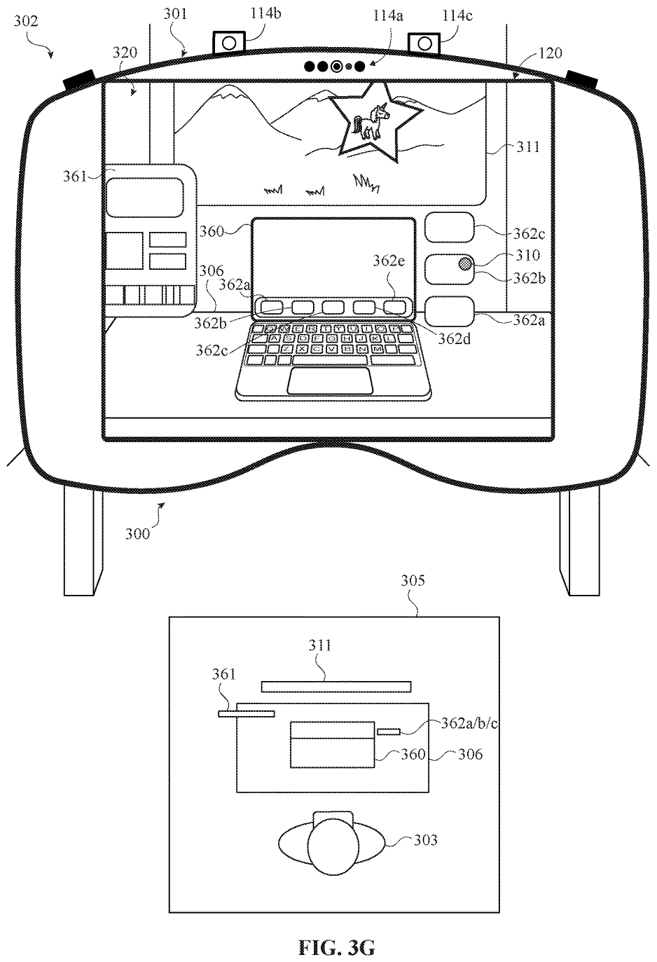

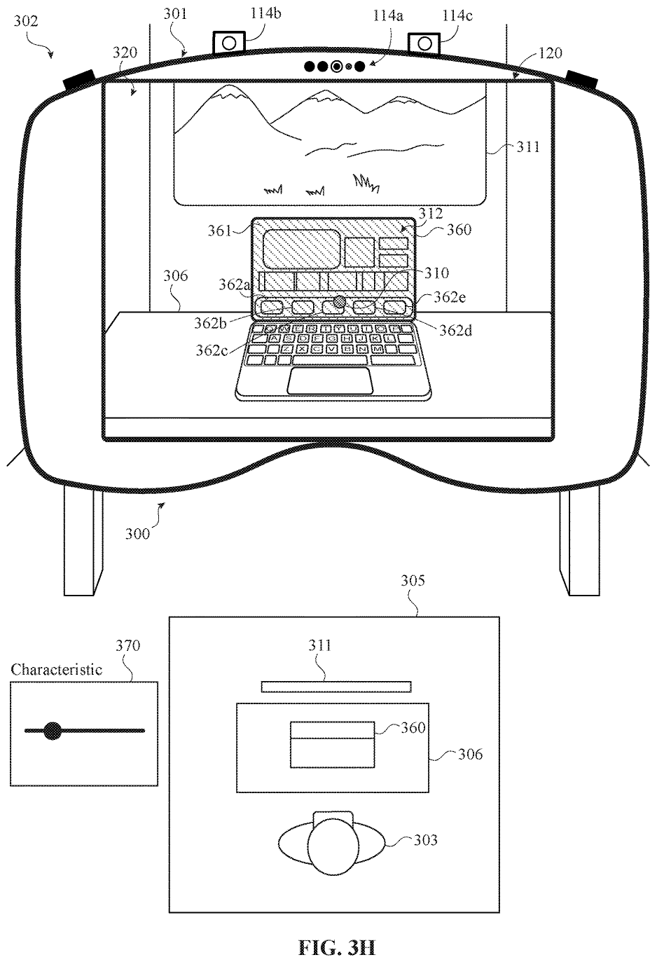

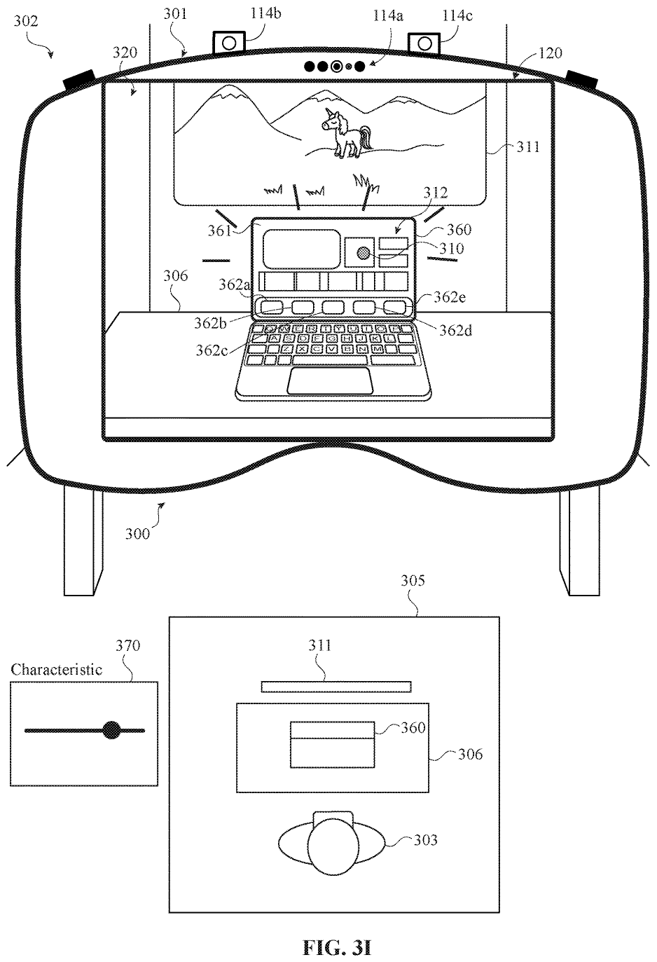

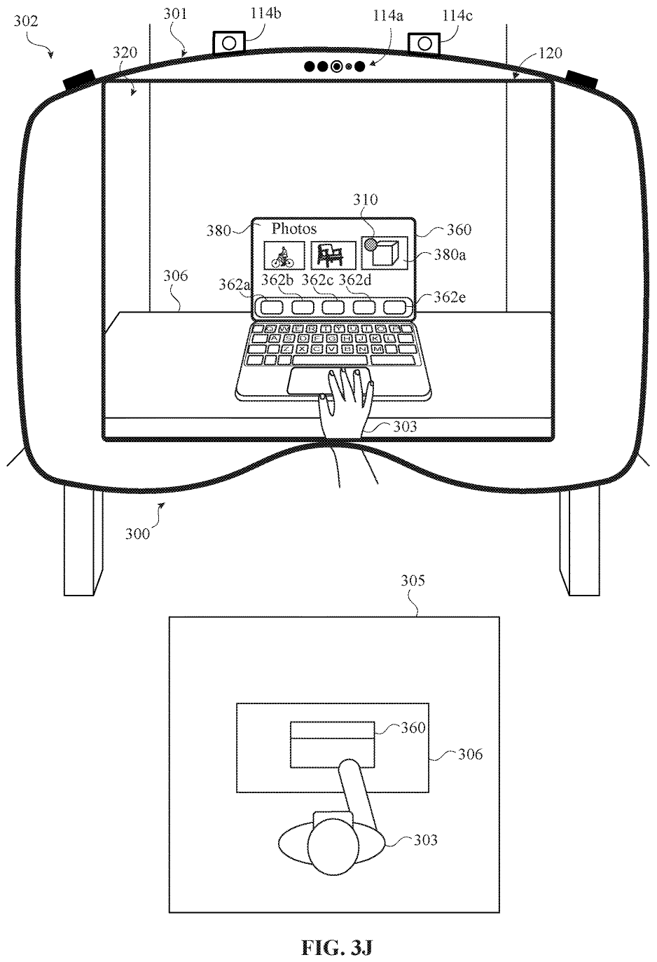

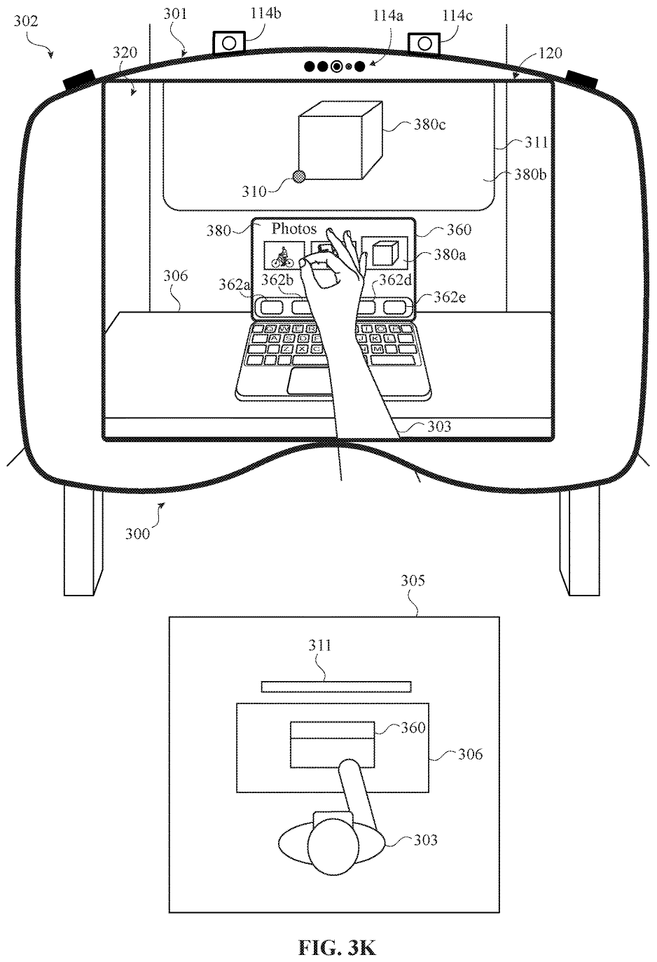

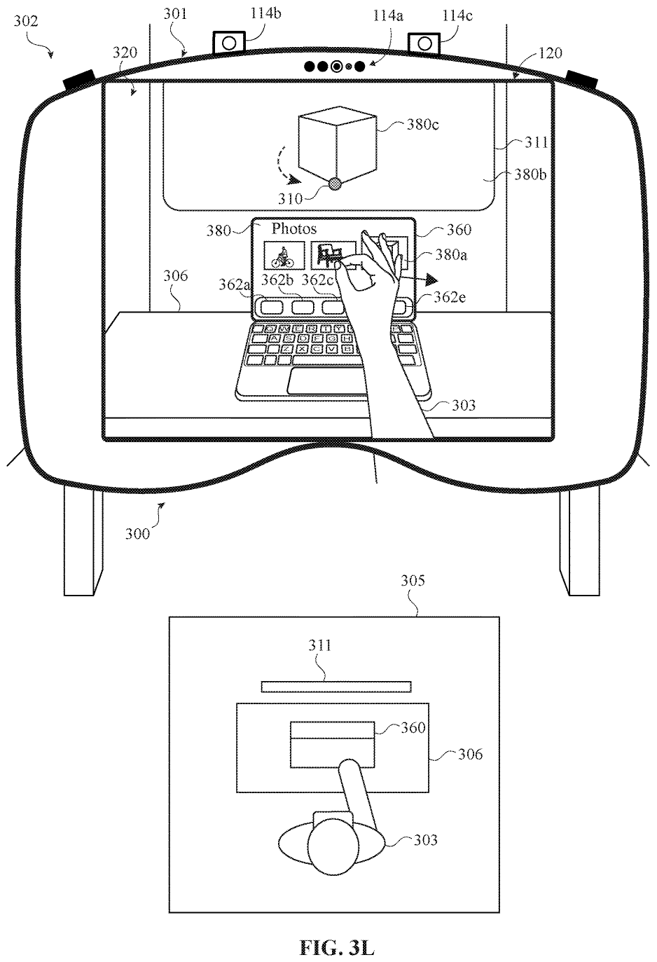

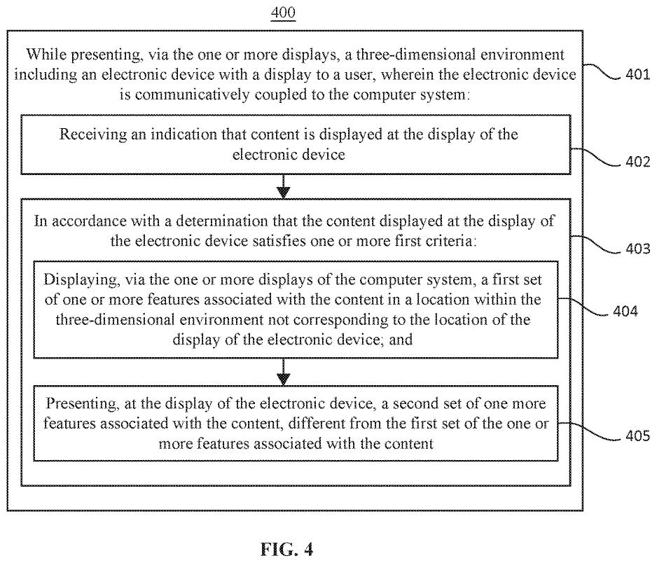

Attention is now directed towards interactions and/or actions with an electronic device within a physical environment in proximity with a wearable device (e.g., corresponding to wearable device 101), described with reference to FIGS. 3A-3L. The interactions illustrated in FIGS. 3A-3L are examples of practicing method 400 illustrated in FIG. 4, though other interactions according to method 400 are possible without departing from the scope of the disclosure.

FIGS. 3A-3L illustrates examples of a user 303 (e.g., optionally corresponding to hand 103) within a physical environment 302 (e.g., optionally corresponding to the physical environment as discussed above with reference to FIGS. 1-2B) wearing a wearable device 301 (e.g., optionally corresponding to wearable device 101 and/or wearable device 201). In one or examples, physical environment 302 can represent a representation of a real-world physical environment that is displayed on the display 120 of wearable device 101. Alternatively, physical environment 302 is presented on wearable device 101 via one or more passthrough lenses of wearable device 101 (e.g., passthrough as described with respect to FIG. 1). In some examples, physical environment 302 includes a second electronic device 360 (e.g., optionally corresponding to electronic device 160 and/or electronic device 260). In some examples, the second electronic device 360 is a separate electronic device that is being operated by user 301 in the physical environment 302 and is communicatively coupled to wearable device 101 (e.g., the wearable device). In some examples, wearable device 301 optionally includes one or more input devices (e.g., optionally corresponding to internal image sensors 114a and/or eye tracking sensors 212) configured to detect a user gaze, and a display (e.g., optionally corresponding to display 120 and/or the one or more display generation components 214A, 214B) configured to present the three-dimensional environment 300 that includes the second electronic device 360 and one or more physical objects. For example, as illustrated in FIGS. 3A-3L, the three-dimensional environment 300 includes a table 306 directly opposing user 303 that second electronic device 360 is disposed upon. In some examples, the second electronic device 360 includes a display 361 configured to display content viewable by the user 303 through the wearable device 301. In some examples, the content displayed at the display 361 includes a plurality of applications 362a-362b arranged along a bottom portion of the display 361 displayed as a series of icons. In some examples, the second electronic device 360 is communicatively coupled to the wearable device 301 and configured to transmit spatial content to the display (e.g., display 320) of the wearable device 301 in response to a command from the wearable device 301 and/or a user input directed to the second electronic device 360 as discussed in further detail below.

FIG. 3A illustrates an exemplary display of an application at both an electronic device and wearable device that are in communication with one another according to one or more examples of the disclosure. In some examples, user 303 operates wearable device 301 (e.g., a first electronic device and/or computer system) while also operating a second electronic device 360 (e.g., a laptop as illustrated in the figure). In some examples, the user 301 can view the second electronic device 360 through the lens and/or one more cameras of wearable device 301. In some examples, such as illustrated by the top-down view 305, the user 303 is wearing the wearable device 301 and positioned opposing and facing (e.g., illustrated by a vector arrow) the second electronic device 360 atop table 306 within the physical environment. In some examples, the second electronic device 360 receives an input provided by the user 303, indicating a selection of an application corresponding to application 362a, such as a video editing application as discussed in further detail below. For example, such as illustrated in FIG. 3A, the user 303 may provide an input (such as with a hand as illustrated by FIG. 3A) at the second electronic device 360 selecting (e.g., “clicking” via a mouse and/or trackpad) application 362a. In some examples, based on the application selected by the input provided by the user 303, the second electronic device 360 can initiate a process to display one or more portions of content associated with the selected application (e.g., by communication with wearable device 301), while optionally also displaying one or more different portions of the content associated with the application on the display of the second electronic device 360 as illustrated in FIG. 3B.

FIG. 3B illustrates an example of a wearable device displaying a portion of visual content associated with an application while a second electronic device displays another portion of the visual content associated with the same application according to one or more examples of the disclosure. In some examples, prior to displaying the spatial content 311, the wearable device 301 and/or the second electronic device 360 determine if a set of criteria is satisfied. In some examples, the second electronic device 360 determines that the first criterion is satisfied in response to a detection of the input provided by the user 303 as discussed above with reference to FIG. 3A (e.g., “selecting” application 362a). In such instances, the second electronic device 360 may determine that the first criterion has been satisfied in response to the user 303 selecting content at the second electronic device 360 to initiate a process to display the spatial content 311 within the three-dimensional environment 300. In some examples, the wearable device 301 and/or the second electronic device 360 determine that a second criterion, different than the first criterion is satisfied in response to a determination that the content selected by the user 303 corresponds to spatial content, such as spatial content 311. In some examples, FIG. 3B illustrate a wearable device 301 displaying a first set of one or more features corresponding to spatial content 311 within the three-dimensional environment 300 while the second electronic device 360 displays a second set of one or more features in response to the input provided by user 303 according to some examples of the disclosure, wherein both the first set of one or more features and the second set of one or more features are both associated with a common software application that is being executed on the electronic device 260. By presenting the first set of features on the wearable device 301 and the second set features on the second electronic device 260, the system reduces visual occlusion of primary content and allows simultaneous access to control elements without overloading either display. In some examples, the input provided by the user 303 corresponds to the selection of application 362a at the second electronic device 360 as discussed with respect to FIG. 3A. In some examples, where the second electronic device 360 is not communicatively coupled to the wearable device 301, the second electronic device 360 displays the first set of one or more features and the second set of one or more features, different than the first set of one or more features at the display of the second electronic device only. However, as illustrated in the example of FIG. 3B, when the second electronic device 360 is communicatively coupled to a wearable device, the second electronic device can coordinate a process in which some portions of the content associated with an application that would have otherwise been displayed on the second electronic device 360 are instead displayed by the wearable device 301, while another portion of the content is still displayed on the display of the second electronic device 360. For example, the display 361 of the second electronic device 360 may include various content (e.g., spatial content 311) applications (e.g., applications 362a-362d) and/or content control options (e.g., second set of one or more features) prior to the user 303 selecting application 362a as illustrated in FIG. 3A. However, in the event that the second electronic device 360 determines that it is communicatively coupled with the wearable device 301, the second electronic device 360 can cease displaying the first set of one or more features and transmit the first set of one or more features to the wearable device 301 to be presented in the three-dimensional environment 300 in response to detecting the input provided by the user 303. In some examples, a first portion of the first set of one or more features corresponds to the spatial content 311, while a second portion of the first set of one or more features corresponds to a spatial content controls system as discussed in further detail below with reference to FIG. 3G. In some examples, the content that is transmitted to the wearable device 301 can include content that is better displayed in a three-dimensional environment (e.g., spatial content 311) while the content that is displayed on display 361 of the second electronic device 360 includes content that is better displayed on the higher resolution display associated with the second electronic device 360. This arrangement enables more efficient utilization of each device's display capabilities, improving visibility of spatial content in the three-dimensional environment while preserving high-resolution rendering for detailed controls. In some examples, such as illustrated by FIG. 3B, in response to the wearable device 301 displaying the spatial content 311, the second electronic device 360 updates the display 361 to include only the second set of one or more features corresponding to a system control user interface (UI) 312 while maintaining the display of the icons associated with applications 362a-362d along a bottom portion of the display 361. For example, such as illustrated in FIG. 3B, the wearable device 301 may present the spatial content 311 optionally corresponding to a spatial video. This spatial video may be displayed in response to the user 303 selecting a video-editing application, such as application 362a as illustrated in FIG. 3A. Upon selecting the video-editing application, the wearable device 301 may display the spatial content 311 (e.g., first set of one or more features) as previously discussed while the second electronic device displays the system control UI 312 (e.g., second set of one or more features) that optionally contains video editing tools such as an editing timeline. In some examples, a portion of the second set of one or more features correspond to the applications 362a-362d. In some examples, such as illustrated by FIG. 3B, the spatial content 311 is displayed as a window/panel within the three-dimensional environment 300 such that the window/panel does not intersect (e.g., spatially conflict) with display 362 relative to the viewpoint of the user 303. For example, such as illustrated by FIG. 3B, the spatial content 311 is positioned within the three-dimensional environment 300 as a window/panel above the second electronic device 360. By presenting the spatial content 311 within the three-dimensional environment 300 while confining the display of the system control UI 312 at the display 361, the user 303 is able to better perceive all aspects of the spatial content 311 that may not be otherwise be perceptible on a two-dimensional display (e.g., display 361) while reserving finer detailed displays (such as content controls) for the higher definition/resolution display 361. By maintaining the spatial content 311 in the user's field of view while keeping the system control UI 312 on the second electronic device 360, the system reduces the need for manual adjustment or head movement, improving user comfort. In some examples, the spatial content 311 is displayed as “immersive content” (not illustrated) such that spatial content 311 overlays a significant portion of the three-dimensional environment 300 (e.g., 50% of the three-dimensional environment 300, 75% of the three-dimensional environment 300, etc.). In some examples, wearable device 301 maintains the display of the spatial content 311 in accordance with continuing to detect the user gaze 310 directed at the spatial content 311. In some examples, such as illustrated by FIG. 3A, the spatial content 311 corresponds to a spatial video. In some examples, spatial video is a type of video that includes depth information and thus can be displayed in three dimensions, allowing for a more immersive, three-dimensional viewing experience on compatible devices (e.g., wearable device 301). This enables users (e.g., user 303) to “move” within or around the scene, creating a sense of depth and realism beyond traditional “flat” videos (i.e., two-dimensional (2D) videos). Displaying spatial video with depth information allows the user 303 to perceive a three-dimensional scene realistically, providing a more immersive experience compared to conventional two-dimensional video.

In some examples, the second electronic device 360 presents one or more interactable controls in tandem with the wearable device 301 displaying the spatial content 311. For example, as illustrated by FIG. 3B, display 361 includes the system control UI 312 configured to alter one or more aspects of the spatial content 311. In some examples, the system control UI 312 corresponds to a spatial video editing user interface. For example, such as illustrated by FIG. 3B, the system control UI 312 includes one or more features (e.g., illustrated as “controls”) configured to alter playback speed, color, saturation, or length of the spatial video as non-limiting examples. In some examples, the system control UI 312 includes a display of a video timeline. By displaying the video timeline at the second electronic device 360 instead of within the three-dimensional environment 300, the user is able to perform spatial video editing on a high-resolution display while simultaneously viewing the spatial content 311 in a three-dimensional environment. In some examples, the video timeline displayed within the system control UI 312 corresponds to the spatial content 311.

FIG. 3C illustrates an alternative example of the wearable device 301 displaying the spatial content 311 and a second set of one or more features corresponding to applications 362a 362d within the three-dimensional environment 300 according to some examples of the disclosure. As discussed above with reference to FIG. 3B, the wearable device 301 may present the spatial content 311 while simultaneously receiving a communication from the second electronic device 360 to display system control UI 312. In the example of FIG. 3C, the second electronic device 360 may additionally transmit a communication to the wearable device 301 that the second electronic device 360 has ceased displaying applications 362a-362d at the display 361 and transmitted a command to the wearable device 301 to initiate the display of these applications within the three-dimensional environment 300. For example, as illustrated by FIG. 3C, the wearable device 301 may present selectable affordance associated with applications 362a-362d as “icons” appearing on either side of the second electronic device 360 within the three-dimensional environment 300. In some examples, the wearable device 301 displays the applications 362a-362d at a larger size within the three-dimensional environment 300 as compared to the display of the applications 362a-362d by the second electronic device 360.

In some examples, the wearable device 301 displays the applications 362a-362d with a predetermined spatial arrangement within the three-dimensional environment 300 relative to the user 303, such as illustrated in FIG. 3C. This predetermined spatial arrangement allows the user 303 to readily access any of the applications 362a-362d in predictable locations within the three-dimensional environment 300. In addition, the predetermined spatial arraignment may be configured to maximize the visibility of content that spatial content 311 while not interfering with the visibility of other content within the three-dimensional environment 300. For example, such as illustrated by FIG. 3C, the applications 362a-362d are presented along the edge of the display 361 without intersecting the display 361 or the spatial content 311 with respect to the viewpoint of the user.

In some examples, the wearable device 301 displays a subset of the applications 362a-362d based on one or more criteria. For example, when the wearable device 301 displays the spatial content 311, the user 303 may optionally select via the user gaze 310 and/or a user input (e.g., touch input, voice input, pressure input) one or more of the applications 362a-362d to be displayed within the three-dimensional environment. These one or more criteria are not necessarily limited to a user input and may optionally be predetermined criteria associated with the wearable device 301 and/or the second electronic device 360. For example, the spatial content 311 may be displayed within the three-dimensional environment 300 at an immersion level not conducive to displaying all the applications 362a-362d or only may be conducive to displaying a subset of the aforementioned applications. In another example, one or more applications of the applications 362a-362d may not be configured to be displayed spatially within the three-dimensional environment 300. In this example, the user 303 may attempt to select to present the applications 362a-362d within the three-dimensional environment 300 and in response, the wearable device 301 may automatically display those applications with spatial display capabilities. Once the applications 362a-362d and the spatial content 311 are displayed within the three-dimensional environment 300, the wearable device 301 may position all the respective virtual objects (e.g., applications 362a-362d, spatial content 311) with specific spatial arrangements relative to the user 303 independent of any future movement by the user 303 as discussed in further detail below.

FIG. 3D illustrates an example of the spatial content 311 displayed by the wearable device 301 changing locations in the three-dimensional environment 300 based on detected changes of the viewpoint of the user 303 according to some examples of the disclosure. In some examples, wearable device 301 displays the spatial content 311 and the applications 362a-362d at a predetermined orientation relative to the user 303. For example, as illustrated by the top-down view 305 of FIG. 3D, the wearable device 301 detects that the user 303 has moved their viewpoint to the left relative to the second electronic device 360 maintains the orientation (e.g., relative to the viewpoint of the user 303) of the spatial content 311 within the three-dimensional environment 300. In some examples, the spatial content 311 may be presented by the wearable device 301 at a distance and/or height with a respective orientation relative to the user 303 (e.g., virtual objects are “viewpoint-locked” at the predetermined height/distance from the user 303) and in the event that the wearable device 301 detects that the user 303 changes their respective viewpoint (e.g., rotates their head/torso/body), at the new respective viewpoint, the spatial content 311 will continue to be displayed at the same distance and/or height with the respective orientation relative to the user 303. This feature may optionally be referred to as a “viewpoint lock” function of the spatial content 311 relative to the user 303. In some examples, such as illustrated by FIG. 3D, when the spatial content 311 is displayed as the window/panel, the wearable device 301 may detect a change in the user viewpoint and accordingly the wearable device 301 updates the display of the spatial content 311 to be displayed at a different location within the three-dimensional environment 300 based on the change of the viewpoint of the user 303. In some examples, the one or more first set of features corresponding to the spatial content 311 has a predetermined orientation within the three-dimensional environment 300 that is independent of the movement of the user 303. This orientation of the spatial content 311 within the three-dimensional environment 300 may be determined based on a determination of a location within the three-dimensional environment 300 where the display of the spatial content 311 does not intersect the second electronic device 360. For example, as illustrated by FIG. 3B, the spatial content 311 is arranged at a location above the second electronic device 360 within the three-dimensional environment 300. In this example, the wearable device 301 may display the spatial content 311 at the location and/or orientation relative to the user 303 within the three-dimensional environment 300 as discussed above, and in response to detecting the user 303 altering their viewpoint, the wearable device 301 may maintain the spatial content at the location and/or orientation relative to the user 303 as illustrated in FIG. 3B. In some examples, the spatial content 311 has a predetermined orientation relative to the location of the second electronic device 360 within the physical environment 302 (e.g., a fixed distance above the second electronic device). For example, if the user 303 shifts their viewpoint to the left (e.g., changes the orientation of their head/body) the wearable device 301 may continue to present the spatial content 311 at the location above the second electronic device 360. In some examples, if the change of the viewpoint of the user 303 is detected, the updated location of the spatial content 311 is determined based on the direction of the change of the viewpoint of the user 303 and a determination (e.g., optionally by the wearable device 301) that the change of the viewpoint of the user 303 is towards a location such that the display of the spatial content 311 does not overlap the second electronic device 360. As discussed herein, the change of the viewpoint of the user 303 may correspond to a movement of the position/orientation of the user 303 in the physical environment 302 and/or the three-dimensional environment 300.

In some examples, the wearable device 301 maintains the display of the spatial content 311 in the three-dimensional environment 300 in response to detecting that the gaze of the user 303 directing the user gaze 310 at the spatial content 311 while adjusting the orientation of their body. In some examples, the wearable device 301 detects the user 303 adjusting the orientation of their body in a variety of directions, and in response, the wearable device 301 continues to present the spatial content 311 and applications 362a-362d at a predetermined orientation in the three-dimensional environment 300 relative to the user 303 contingent on the wearable device 301 detecting the user gaze 310 directed at any of the virtual objects in the three-dimensional environment 300. For example, the user 303 may direct their attention away from the spatial content 311 and/or the second electronic device 360 in response to other stimuli in the physical environment and/or the three-dimensional environment 300 (e.g., notification from wearable device 301, environmental noise from the periphery of user 303 field of view), and in response, the wearable device 301 may cease displaying the spatial content 311 and/or the applications 362a-362d as discussed in further detail below with reference to FIG. 3E.

FIG. 3E illustrates an example of the wearable device 301 ceasing the display of the spatial content 311 and/or the applications 362a-362d and transmitting a command to the second electronic device 360 to present the aforementioned virtual objects at the display 361 according to some examples of the disclosure. In some examples, such as discussed above with reference to FIG. 3D, the wearable device 301 may optionally cease the display of the spatial content 311 and/or applications 362a-362d upon detecting that the user gaze 310 is no longer directed at the spatial content 311 and is instead directed to the display of second electronic device 360. In this example, as illustrated by FIG. 3E, in addition to the wearable device 301 ceasing the display of the spatial content 311, the wearable device 301 may optionally transmit a command to the second electronic device 360 to initiate a process to present the spatial content 311 and the applications 362a-362d at the display 361. In some examples, the second electronic device 360 displays the aforementioned virtual objects in response to a command received from wearable device 301 that is transmitted upon the wearable device 301 detecting the direction of the user gaze 310 at the second electronic device 360 and specifically at display 361. In some examples, the second electronic device 360 does not display the content that was previously displayed by wearable device 301 unless the wearable device 301 detects the direction of the user gaze 310 being directed at the display 361. For example, the wearable device 301 may detect that the user gaze 310 has moved from the spatial content 311 (e.g., as shown in FIG. 3D) to a portion of the second electronic device 360 that does not include the display 361, such as a keyboard associated with the second electronic device 360. In this instance, the wearable device 301 may determine that the user attention (optionally determined by the direction of the user gaze 310) may still be directed to the spatial content 311 in the three-dimensional environment 300 and continue to present the spatial content 311 within the three-dimensional environment 300. In some examples, the second electronic device 360 displays the system control UI 312 prior to the wearable device 301 detecting the user gaze 310 at the second electronic device 360. In some examples, prior to the wearable device 301 detecting the user gaze 310 at the second electronic device 360, the wearable device 301 displays only the spatial content 311 within the three-dimensional environment 300 while the second electronic device 360 displays the system control UI 312 and applications 362a-362d, such as illustrated in FIG. 3B.

In some examples, in response to the wearable device 301 detecting the user gaze 310 at the second electronic device 360, such as illustrated by FIG. 3E, the display 361 may include a “split” display of the spatial content 311 and the system control UI 312. This example layout of the configuration of the spatial content 311, system control UI 312 and (optionally) applications 362a-362d at the display 361 as shown by FIG. 3E should be understood as non-limiting and may be arranged in a variety of manners such as a tiled arrangement (side-by-side or grid layouts), stacked arrangement (vertical or horizontal splits), floating arrangement (overlapping & movable windows) and the like. This arrangement of content at the display 361 may optionally be determined by a user selection and/or dictated by the firmware of the wearable device 301 and/or the second electronic device 360. In some examples, the wearable device 301 automatically ceases the display of the spatial content 311 and initiates the display of the spatial content 311 at the second electronic device 360 in response to one or more detected conditions. For example, the user 303 may provide a user input directed towards any one of the applications 362a-362, such as a movement of a cursor or the user gaze 310 over application 362a, and prior to the user selecting the application 362a, the wearable device 301 may cease displaying the spatial content 311 and transmit the command to the second electronic device 360 to present the spatial content. In another example, the user 303 may provide a user input (e.g., such as user gaze 310) directed at the system control UI 312 to alter one or more aspects of the spatial content 311 such that the spatial content 311 is no longer able to be displayed within the three-dimensional environment 300. In response, the wearable device 301 may automatically cease the display of the spatial content 311 and transmit a command to the second electronic device 360 to begin displaying the spatial content 311. In some examples, the user 303 may provide a user input directed at the system control UI 312 that alters one or more aspects of the spatial content 311 that does not result in the spatial content 311 being unable to be displayed within the three-dimensional environment 300 as discussed in further detail below.

FIG. 3F illustrates an example of the wearable device 301 altering one or more aspects of the spatial content 311 in response to detecting an input provided by user 303 directed at the system control UI 312 according to some examples of the disclosure. The one or more aspects may correspond to a variety of video editing controls, such as speeding up or slowing down spatial video in one example. In some examples, the wearable device 301 automatically reflects changes to the display of the spatial content 311 within the three-dimensional environment 300 as dictated by input provided by the user 303 directed at the system control UI 312. This user input may be provided by, but not limited to, a touch input, a pressure input, a keyboard input, or a mouse input detected at the second electronic device 360.

In some examples, the spatial content 311 corresponds to a spatial video that the user 303 may desire to edit. Editing “regular” video (i.e., non-spatial video) involves working with a standard flat (2D) frame, where the user may control cuts, transitions, and effects within a fixed perspective. In contrast, editing spatial video (such as 3D or 360-degree video) can require managing depth, perspective shifts, and sometimes interactive elements, ensuring that the visuals presented remain immersive and comfortable for viewers across multiple angles. In some examples, the wearable device 301 may continue to present the spatial content 311 within the three-dimensional environment 300 while the user 303 optionally performs edits (e.g., altering one or more aspects) to the spatial content 311 via the content controls UI 312. In some examples, such as shown in FIG. 3F, the wearable device 301 detects the input provided by the user 303 selecting the system control UI 312 at the second electronic device 360, and in response, the wearable device 301 updates the display of the spatial content 311 with the inclusion of the “star” within the content.

FIG. 3G illustrates an alternative example of the wearable device 301 altering one or more aspects of the spatial content 311 in response to a user input directed at the system control UI 312 according to some examples of the disclosure. In some examples, in response to the user 303 selecting a spatial video editing application (e.g., user 303 selection of application 362a as shown in FIG. 3A), the wearable device 301 displays the spatial content 311, the system control UI 312, and a plurality of interactable controls 355a-355c within the three-dimensional environment 300.

In some examples, such as shown in FIG. 3G, the wearable device 301 displays the system control UI 312 at a position to the left of the second electronic device 360 and the interactable controls 355a-355c at a position to the right of the second electronic device 360 within the three-dimensional environment 300 relative to the user 303. Displaying these virtual objects with this spatial arrangement allows for the user 303 to perform edits to the spatial content 311 in a similar manner as discussed above with reference to FIG. 3F at a higher immersion level, thus optionally lowering the need for the user 303 to provide inputs to the second electronic device 360. In some examples, such as illustrated by FIG. 3G, the wearable device 301 detects the user gaze 310 directed at a content control 355b and alters one or more aspects of the spatial content 311 in response. In some examples, the wearable device 301 may update the display of the system control UI 312 to include only a display of a “spatial video timeline” and “push” the other content controls out into the three-dimensional environment 300 as the interactable controls 355a-355c. For example, spatial content control 355a may correspond to a play/pause control associated with the spatial content 311. In some examples, the wearable device 301 modifies one or more aspects of the spatial content 311 in response to detecting the user gaze 310 directed at the content control 355b combined with detecting a user gesture directed at the content control 355b. This user gesture may optionally correspond to a “pinch and/or drag” gesture provided by the user 303 detected by the one or more cameras of the wearable device 301. In some examples, the wearable device 301 maintains the display of the spatial content 311, the system control UI 312, and/or the interactable controls 355a-355c while the user gaze 310 is directed at any of the aforementioned virtual objects. As discussed above, the wearable device 301 optionally includes a gaze-criterion such that virtual objects (e.g., spatial content 311 or interactable controls 355a though 355c) are only displayed while the user 303 directs their attention towards them in the three-dimensional environment 300. In such instances, the wearable device 301 may detect that the user 303 directs their attention (e.g., user gaze 310) towards a respective content control of the content controls 355a-355c, and in response to an additional detection of a “air pinch” gesture provided by the user 303, perform one or more edits to the spatial content 311. While the one or more edits are occurring, the wearable device 301 optionally continues to present the spatial content 311, and cease displaying the spatial content 311 upon detecting that the user 303 attention has diverted from the respective content control. In some examples, such as illustrated in FIG. 3G, while the wearable device 301 displays the spatial content 311, the system control UI 312, and/or the interactable controls 355a-355c, the second electronic device 360 displays applications 362a-362d along the bottom portion of the display 361 (e.g., within a “dock”). In this example, the wearable device 301 may present the spatial content 311 and the applications 362a-362d within the three-dimensional environment 300 in a similar manner as illustrated by FIG. 3D prior to the user 303 directing their attention towards the system control UI 312 at the second electronic device 360. Upon detecting the user gaze 310 directed towards the system control UI 312, the wearable device 301 may cease the display of the applications 362a-362d and transmit a command to the second electronic device 360 to present applications 362a-362d in tandem with the wearable device 301 initiating the display of the system control UI 312 and/or the content controls 355a-355c.

The aforementioned examples should be considered non-limiting, as various other configurations may be implemented. More or fewer content controls may be displayed, depending on the specific implementation, each configured to modify one or more aspects of the spatial content 311 that is displayed. These controls can be adjusted dynamically to accommodate different user preferences, interaction modes, or system requirements of the wearable device 301 and/or the second electronic device 360. In some examples, the wearable device 301 modifies one or more aspects of the three-dimensional environment 300 in lieu of modifying the one or more aspects of the displayed spatial content based on the different user preferences, interaction modes, or system requirements as discussed in further detail below. For example, as illustrated in FIG. 3H, the wearable device 301 may transmit a command to the second electronic device 360 to lower the brightness of the display 361 in tandem with displaying the spatial content 311 within the three-dimensional environment 300.

FIG. 3H illustrates an example of the wearable device 301 transmitting a command to the second electronic device 360 to lower the brightness of the display 361 in response to the wearable device 301 displaying the spatial content 311 according to some examples of the disclosure. This change of the display 361 may not be limited to a change in brightness and may in other examples include alterations of various visual characteristics of the content displayed at the second electronic device 360 such as, but not limited to, changes in color, transparency, tinting, and/or color saturation. In some examples, the user 303 may desire to view spatial content such as spatial video. When viewing spatial content 311 within the three-dimensional environment 300 various color grading, lighting, or physical environmental factors may obscure the viewing ability of the user 303 of the spatial content 311. As an automatic response to combat these factors, the wearable device 301 may transmit the command to the second electronic device 360 to lower the brightness of the display 361 upon a determination that the user 303 has selected to view spatial content 311, such as described above with reference to FIG. 3A. In some examples, such as described above with reference to FIGS. 3A and 3B, the user 303 selects the video editing application and in response, the wearable device 301 displays the spatial content 311 within the three-dimensional environment 300 in tandem with the second electronic device 360 lowering the brightness of the display 361 as illustrated in FIG. 3H. In some examples, the wearable device 301 automatically applies the change in brightness to the entire three-dimensional environment 300 to increase the visibility of the spatial content 311. This change in brightness is optionally characterized by glyph 370 illustrated on the left-hand side to indicate a decrease in brightness. For example, glyph 370 may indicate a “default” brightness of the three-dimensional environment 300 and/or display 361. In some examples, the change in brightness is determined by a user input. In such instances, the wearable device 301 may present a control user interface within the three-dimensional environment 300 optionally corresponding to any of the applications 362a-362d and/or content controls 355a-355c. In some examples, in response to a detection of the user gaze 310 directed at any of the aforementioned virtual objects, the wearable device 301 lowers/increases the brightness of the three-dimensional environment 300 and/or the display 361.

FIG. 3I illustrates an example of the wearable device 301 transmitting a command to the second electronic device 360 to increase the brightness of the display 361 in response to the wearable device 301 detecting the user gaze 310 directed at the display 361 while displaying the spatial content 311 according to some examples of the disclosure. In some examples, such shown by glyph 370, the wearable device 301 automatically increases the brightness of the display 361 while displaying the spatial content 311 within the three-dimensional environment 300. In some examples, the increase in brightness of the display 361 is determined by the type of application selected by the user 303. For example, the user 303 may select an application corresponding to a video editing application at the second electronic device 360, and in response, the wearable device 301 may present the spatial content 311 within the three-dimensional environment 300 and transmit the command to the second electronic device 360 to present the system control UI 312 such as illustrated in FIG. 3B. In this example, the wearable device 301 may additionally command the second electronic device 360 to increase the brightness of the display 361 to increase the visibility of the system control UI 312 for the user 303.

FIG. 3J illustrates the second electronic device 360 presenting a photo gallery 380 in response to the wearable device 301 detecting an input provided by user 303 directed at a photo gallery application (e.g., application 361a as illustrated in FIG. 3I) according to some examples of the disclosure. For example, such as illustrated in FIG. 3J, the user 303 may provide a “click” input at the trackpad of the second electronic device 360, indicating a selection of the application 361a. In some examples, the photo gallery 380 comprises a catalogue of digital images/content items organized in a grid or list format, allowing users (e.g., user 303) to browse and select photos through gaze input, touch interactions, or other input modalities, such as the user gaze 310. The displayed images/content items may be locally stored on the second electronic device 360, synchronized from a cloud-based photo storage service, or dynamically retrieved from a connected device such as the wearable device 301 or external storage drive. In some examples, the layout of the catalogue of digital images/content items may be adaptive, resizing or reorganizing based on the available display area or the user's interaction patterns. In some examples, while the photo gallery 380 is displayed at the display 361, the second electronic device 360 detects a user input directed to a specific photo/content item (e.g., photo in photo gallery 380). For example, as illustrated by FIG. 3J, the wearable device 301 detects that user 303 may extend their arm to the keypad at the second electronic device 360 indicating a selection of the photo 380a. In response, the second electronic device 360 may initiate a process to display the photo 380a within the three-dimensional environment 300 as discussed in further detail below. In some examples, the process to display the photo 380a may require satisfying two criterions, similar to the first and second criterion discussed above with reference to FIG. 3B. For example, the second electronic device 360 may detect that a first criterion is satisfied in response to detecting the user input directed at the photo 380a as discussed above. Additionally, the wearable device 301 and/or the second electronic device 360 may analyze the selected image's (e.g., photo 380a) metadata to determine whether the content item is spatial or non-spatial. If the content item is identified as spatial content, the wearable device 301 and/or the second electronic device 360 may determine that a second criterion is satisfied and in response, the wearable device 301 may display the photo 380a in the three-dimensional environment 300 as spatial content as discussed in further detail below with reference to FIG. 3K. In some examples, if the selected photo (e.g., photo 380a) is determined to be a non-spatial content item (e.g., the second criterion is not satisfied), the second electronic device 360 may either forgo display of the photo 380a in the three-dimensional environment 300 by wearable device 301 or initiate a process to present photo 380a as a non-spatial window above the second electronic device 360, as illustrated in FIG. 3K. For instance, a traditional two-dimensional Joint Photographic Experts Group (JPEG) image may be displayed in a floating rectangular frame within the three-dimensional environment 300 rather than being integrated into the three-dimensional environment 300.

In some examples, rather than being displayed at the display 361, the wearable device 301 may alternatively present the photo gallery 380 as a floating window within the three-dimensional environment 300. In some examples, the user 303 may configure the wearable device 301 to automatically transition the photo gallery between the display 361 and the three-dimensional environment 300 based on user engagement patterns, such as shifting gaze focus (e.g., gaze 310) from the wearable device 301 to the surrounding space. Additionally, in some examples, when the photo gallery 380 is displayed in the three-dimensional environment 300, the user 303 may be able to spatially arrange images around them, pin favorite photos to specific virtual locations, or view depth-enhanced images in a more immersive manner. In some examples, such as illustrated by FIG. 3J, the wearable device 301 determines that the selected photo 380a is a spatial content item and in response, displays the photo 380a within the three-dimensional environment 300 as discussed in further detail below.

FIG. 3K illustrates an example of the wearable device 301 displaying a spatial photo 380b with one or more spatial properties within the three-dimensional environment 300 in response to a user selection (e.g., optionally by the user gaze 310) according to some examples of the disclosure. In some examples, in response to the second electronic device 360 detecting the user 303 directing an input at the second electronic device 360, the wearable device 301 displays the selected photo 380a as a spatial photo 380b within the three-dimensional environment 300. In some examples, once displayed, the spatial photo 380b can be dynamically manipulated by wearable device 301. For example, such as illustrated by FIG. 3K, the wearable device 301 detects the user 303 directing an input (e.g., a “pinch and drag”) as at a portion of the spatial photo corresponding to a cube 380c and in response, performs an object manipulation (e.g., altering the one or more spatial properties) as described in further detail below. In some examples, such as illustrated in FIG. 3K, the user 303 performs an “air pinch” gesture directed at the cube 380c while directing the user gaze 310 at the cube 380c. In such cases, in response to the “air pinch” gesture, the wearable device 301 may continue to display the cube 380c within the three-dimensional environment 300 while updating the orientation of the spatial photo 380b. In some examples, the wearable device 301 detects the “air pinch” gesture provided by the user 303 moving to the right, such as illustrated in FIG. 3K, and in response, updates the orientation of the spatial photo 380b to rotate right relative to the viewpoint of the user 303 within the three-dimensional environment 300. In some examples, when the spatial photo 380b containing the cube 380c is displayed within the three-dimensional environment 300, the wearable device 301 renders the image with depth, making the cube appear as though it is floating or positioned within a three-dimensional environment 300 above the second electronic device 360. In some examples, the cube 380c maintains realistic spatial positioning and perspective, adjusting dynamically as the user 303 shifts their viewpoint, reinforcing the illusion of depth. In some examples, as the user 303 moves their head or eyes, the wearable device 301 updates the display in real time, allowing the cube 380c to be observed from multiple angles. In some examples, lighting and shading effects can be applied to the cube 380c within the spatial photo 380b, enhancing realism by simulating shadows, reflections, or highlights that shift based on the virtual light sources and the user 303 perspective. In some examples, the cube 380c can remain static within the spatial photo 380b or be interactively manipulated, such as rotated or repositioned within the three-dimensional environment 300, depending on the functionality enabled by the wearable device 301 and the user's input.

In some examples, the level of immersion for the cube 380c within the spatial photo 380b can be dynamically adjusted, either manually by the user 303 or automatically by the firmware of the wearable device 301 and/or the second electronic device 360, depending on predefined settings or contextual factors. In some examples, the wearable device 301 further detects the user gaze 310 directed at the cube 380c, which serves as a command to initiate a rotation of the cube 380c, as discussed in further detail with reference to FIG. 3L. In some examples, such as shown by FIG. 3K, the user gaze 310 is directed upward at the cube 380c, triggering an interaction recognized by the wearable device 301 input sensors.

FIG. 3L illustrates an example of the user 303 manipulating the cube 380c within the three-dimensional environment 300 according to some examples of the disclosure. In some examples, when the cube 380c is rotated within the three-dimensional environment 300 by the input provided by the user 303, it appears to spin smoothly around a selected axis, providing a sense of depth and perspective as it shifts orientations. In some examples, the rotation can be controlled by the direction and duration of the input provided by the user 303, such that the input (e.g., optionally provided by the “air pinch” gesture as shown in FIG. 3L) provided by user 303 is a movement to the left causes the cube 380c to rotate along its vertical axis, while the input provided by the user 303 is in the up or down direction results in rotation along the horizontal or depth axes. In some examples, the wearable device 301 calculates the real-time position of the cube 380c and applies transformation matrices to simulate realistic motion, adjusting for the user 303 viewpoint and ensuring that the rotation appears natural and continuous. In some examples, the device may also incorporate motion smoothing or inertia effects, allowing the cube 380c to gradually slow down rather than stopping abruptly, mimicking the physical behavior of a real-world object within the three-dimensional environment 300. In some examples, the spatial photo 380b corresponds to any variety of three-dimensional objects including, but not limited to, a sphere, cylinder, cone, pyramid, or any other variety of real-world objects.

It is understood that the examples shown and described herein are merely exemplary and that additional and/or alternative elements may be provided within the three-dimensional environment for displaying spatial content within the three-dimensional environment 300. It should be understood that the appearance, shape, form, and size of each of the various user interface elements and objects shown and described herein are exemplary and that alternative appearances, shapes, forms and/or sizes may be provided. Additionally or alternatively, in some examples, the various options, user interface elements, control elements, etc. described herein may be selected and/or manipulated via user input received via one or more input devices in communication with the electronic device (or electronic devices). For example, selection input may be received via physical input devices, such as a mouse, trackpad, keyboard, etc. in communication with the electronic devices (or electronic devices), or a physical button integrated with the electronic devices (or electronic devices).

FIG. 4 is a flow diagram illustrating a method 400 of displaying immersive content (e.g., spatial content) within the three-dimensional environment 300 according to some examples of this disclosure. The method is optionally performed at one or more devices described above with reference to FIGS. 1 through 3L (e.g., wearable device 101, electronic device 160, wearable device 201, electronic device 260, wearable device 301, second electronic device 360). Some operations in method 400 are, optionally, combined, repeated, and/or skipped and/or the order of some operations is, optionally, changed without departing from the scope of the disclosure. In some examples, the one or more device described above with reference to FIGS. 1 through 3L includes non-transitory computer readable media as described herein storing instructions for executing one or more steps of method 400.

In some examples, at operation 401, in accordance with the method 400, the wearable device displays a three-dimensional environment that includes a second electronic device with a display to a user. In some examples, the wearable device corresponds to the wearable device 101, 201, or 301 as described above with reference to FIGS. 1 through 3L. In some examples, the wearable device captures one or more images of a physical environment to present a three-dimensional environment (e.g., three-dimensional environment 300) that includes physical objects present in the physical environment, such as a table (e.g., table 106, 306). In some examples, the three-dimensional environment additionally includes the second electronic device, such as a laptop, at the table that is communicatively coupled to the wearable device. In some examples, the wearable device includes in the three-dimensional environment a display at the second electronic device that presents various content as described in further blocks below. In some examples, the wearable device captures content displayed at the second electronic device and presents the content within the three-dimensional environment. In some examples, the wearable device is worn by a user (e.g., user 303) and presents a portion of the physical environment as the three-dimensional environment.

In some examples, at operation 402, in accordance with the method 400, the wearable device receives an indication that content is displayed at the second electronic device (e.g., second electronic device 360), such as a wireless transmission, according to some examples of the disclosure. In some examples, the wearable device receives the indication via the one or more input devices such as external image sensors 114b and 114c. For example, the second electronic device may display an image at the display of the second electronic device that may be subsequently captured by the external image sensors 114b and 114c and presented by the wearable device as within the three-dimensional environment. In some examples, the indication corresponds to the detection of the user gaze 310 as discussed above with reference to FIG. 3A. In some examples, the indication is automatically generated by the second electronic device and transmitted to the wearable device in response to a user selecting content at the electronic device.

In some examples, at operation 403, in accordance with the method 400, the wearable device determines that the content displayed at the second electronic device satisfies one or more criteria according to some examples of the disclosure. In some examples, the one or more criteria corresponds to one or more characteristics associated with the content. For example, the content may correspond to spatial content as described above with reference to FIGS. 3A through 3L. In some examples, the wearable device determines that the one or more criteria are satisfied upon a determination that the content is able to be displayed within the three-dimensional environment. For example, the content may be two-dimensional content, such as an image, and may not be able to be properly displayed within the three-dimensional environment. In such cases, the wearable device may not display such content. In some examples, the one or more criteria are determined to be satisfied based on a determination that environmental conditions within the physical environment are conducive to displaying the content within the three-dimensional environment. For example, the physical environment may have a sufficient level of lighting to allow proper viewing of the content by the user within the three-dimensional environment.

In some examples, at operation 404, in accordance with the method 400, the wearable device presents a first set of one or features associated with the content within the three-dimensional environment according to some examples of the disclosure. In some examples, the first set of one or more features correspond to the spatial content 311 as described above with reference to FIGS. 3A through 3L. In some examples, the wearable device presents the one or more first features as multiple types of content such as spatial content 311 and the applications 362a-362d as discussed above in FIG. 3C. In some examples, the wearable device presents the one or more features in a location within the three-dimensional environment such that the second electronic device (e.g., electronic device 160, 260, 360) is fully visible from the viewpoint of the user 303. For example, as illustrated in FIG. 3C, the spatial content 311 (e.g., the first set of one or more features) is position in a location above the second electronic device within the three-dimensional environment 300. In some examples, the first set of one or more features corresponds to the applications 362a-362d as illustrated in FIG. 3C. In some examples, the first set of one or more features correspond to system control UI 312 configurable to alter one or more aspects of the spatial content as discussed above with reference to FIG. 3G.

In some examples, at operation 405, in accordance with the method 400, the wearable device displays a second set of one or more features associated with the content at the second electronic device according to some examples of the disclosure. In some examples, the second set of one or more features are associated with the content such as system control UI 312, such as illustrated in FIG. 3F. For example, the wearable device may present the first set of one or more features in the three-dimensional content as spatial content (e.g., spatial content 311) within the three-dimensional environment while the second electronic device displays the second set of one or more features (e.g., content controls UI 312). In some examples, the first set of one or more features are different than the second set of one or more features such as previously described.

It should be understood that the particular order in which the operations of the flowchart of FIG. 8 have been described is merely exemplary and is not intended to indicate that the described order is the only order in which the operations could be performed. One of ordinary skill in the art would recognize various ways to reorder the operations described herein.

Therefore, according to the above, some examples of the disclosure are directed to a method comprising, at a wearable device in communication with one or more displays and one or more input devices, while presenting, via the one or more displays, a three-dimensional environment including a second electronic device with a display, wherein the second electronic device is communicatively coupled to the wearable device. Additionally or alternatively to one of more of the examples disclosed above, in some examples, the method comprises receiving an indication that content is displayed at the display of the second electronic device, and in accordance with a determination that the content displayed at the display of the second electronic device satisfies one or more first criteria, presenting, via the one or more displays of the wearable device, a first set of one or more features associated with the content in a location within the three-dimensional environment different from the location of the display of the second electronic device, and presenting, at the display of the second electronic device, a second set of one or more features associated with the content, different from the first set of the one or more features associated with the content. Additionally or alternatively to one of more of the examples disclosed above, in some examples, the method further comprises, while presenting the first set of one or more features in the location within the three-dimensional environment different from the location of the display of the second electronic device, detecting, via the one or more input devices, an attention of a user directed to the display of the second electronic device, and in response to detecting the attention of the user directed to the display of the second electronic device, ceasing the presentation of the first set of one or more features at the location within the three-dimensional environment different from the location of the display of the second electronic device and displaying the first set of one or more features at the display of the second electronic device. Additionally or alternatively to one of more of the examples disclosed above, in some examples, the second set of one or more features associated with the content includes a control user interface configured to modify one or more aspects of the content. Additionally or alternatively to one of more of the examples disclosed above, in some examples, the first set of one or more features associated with the content corresponds to spatial content. Additionally or alternatively to one of more of the examples disclosed above, in some examples, the method further comprises detecting, via the one or more input devices, a user input corresponding to a selection of a feature of the second set of one or more features associated with the content, wherein the feature corresponds to an application associated with the second electronic device. Additionally or alternatively to one of more of the examples disclosed above, in some examples, in response to detecting the user input, ceasing a display of a subset of the second set of one or more features associated with the content at the display of the second electronic device, wherein the subset corresponds to interactable controls associated with the application and updating, via the one or more displays, the first set of one or more features associated with the content to include the subset of the second set of one or more features associated with the content. Additionally or alternatively to one of more of the examples disclosed above, in some examples, the second set of one or more features displayed at the second electronic device corresponds to a catalogue of one or more content items, the method further comprising, in accordance with a detection of a selection of a first content item of the one or more content items, updating, via the one or more displays, the first set of one or more features associated with the content to include the first content item. Additionally or alternatively to one of more of the examples disclosed above, in some examples, the method further comprises, in accordance with a determination that the first content item corresponds to spatial content, presenting, via the one or more displays, the first content item as spatial content. Additionally or alternatively to one of more of the examples disclosed above, in some examples, the method further comprises, while presenting the first set of one or more features within the three-dimensional environment different from the location of the display of the second electronic device, wherein the location different from the location of the display of the second electronic device corresponds to a first location within the three-dimensional environment relative to a user. Additionally or alternatively to one of more of the examples disclosed above, in some examples, in response to a detection, via the one or more input devices, of a first movement of the user, maintaining the presentation of the first set of one or more features at the first location within the three-dimensional environment. Additionally or alternatively to one of more of the examples disclosed above, in some examples, the method further comprises, in accordance with a detection, via the one or more input devices, of an attention of a user directed to the display of the second electronic device, transmitting a command to the second electronic device to increase a brightness of the display of the electronic device. Additionally or alternatively to one of more of the examples disclosed above, in some examples, the method further comprises, in accordance with a determination that the first set of one or more features associated with the content satisfies the one or more first criteria, transmitting a command to the second electronic device decrease a brightness of the display of the electronic device. Additionally or alternatively to one of more of the examples disclosed above, in some examples, the first set of one or more features includes one or more system control user interfaces associated with the second electronic device. Additionally or alternatively to one of more of the examples disclosed above, in some examples, the one or more first criteria include a first criterion that is satisfied in accordance with detecting a user input directed at the content displayed at the display of the second electronic device selecting the content to be presented in the location within the three-dimensional environment different from the location of the display of the second electronic device, and a second criterion, different than the first criterion, that is satisfied in accordance with determining that the content displayed at the display of the second electronic device selected by the user input corresponds to spatial content. Additionally or alternatively to one of more of the examples disclosed above, in some examples, the first set of one or more features are presented at a larger size at the first location within the three-dimensional environment different from the location of the display of the second electronic device than a size of the first set of one or more features when presented on the display of the second electronic device. Additionally or alternatively to one of more of the examples disclosed above, in some examples, the method further comprises, in accordance with a determination that the content displayed at the display of the second electronic device satisfies a first criterion of the one or more first criteria, detecting, via the one or more input devices, a first user input directed at the content displayed at the display of the second electronic device, updating, via the one or more displays, the first set of one or more features associated with the content to include the content at the location within the three-dimensional environment different from the location of the display of the second electronic device, wherein the content is displayed with one or more spatial properties, and in accordance with a detection, via the one or more input devices, of a second user input, different than the first user input, directed at the content displayed at the location within the three-dimensional environment different from the location of the display of the second electronic device, updating, via the one or more displays, an aspect of the one or more spatial properties.

Some examples of the disclosure are directed to a wearable device, comprising one or more displays, one or more input devices, one or more processors, memory, and one or more programs, wherein the one or more programs are stored in the memory and configured to be executed by the one or more processors, the one or more programs including instructions for, while presenting, via the one or more displays, a three-dimensional environment including a second electronic device with a display, wherein the second electronic device is communicatively coupled to the wearable device, receiving an indication that content is displayed at the display of the second electronic device, and in accordance with a determination that the content displayed at the display of the second electronic device satisfies one or more first criteria, presenting, via the one or more displays of the wearable device, a first set of one or more features associated with the content in a location within the three-dimensional environment different from the location of the display of the second electronic device, and presenting, the display of the second electronic device, wherein the display of the second electronic device displays a second set of one or more features associated with the content, different from the first set of the one or more features associated with the content.

Some examples of the disclosure are directed to a non-transitory computer readable storage medium storing one or more programs, the one or more programs comprising instructions, which when executed by one or more processors of a wearable device in communication with one or more displays and one or more input device, cause the wearable device to perform, while presenting, via the one or more displays, a three-dimensional environment including a second electronic device with a display, wherein the second electronic device is communicatively coupled to the wearable device, receiving an indication that content is displayed at the display of the second electronic device, and in accordance with a determination that the content displayed at the display of the second electronic device satisfies one or more first criteria, presenting, via the one or more displays of the wearable device, a first set of one or more features associated with the content in a location within the three-dimensional environment different from the location of the display of the second electronic device, and presenting, the display of the electronic device, wherein the display of the second electronic device displays a second set of one or more features associated with the content, different from the first set of the one or more features associated with the content.

Some examples of the disclosure are directed to a non-transitory computer readable storage medium storing one or more programs, the one or more programs comprising instructions, which when executed by the one or more processors of an electronic device, cause the electronic device to perform any of the above methods.

Some examples of the disclosure are directed to an electronic device comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some examples, the data utilized by the wearable device (e.g., wearable device 155, wearable device 255) can include personal information data that uniquely identifies or can be used to contact or locate a specific person. Such personal information data can include demographic data, content consumption activity, location-based data, telephone numbers, email addresses, social media ID's, home addresses, data or records relating to a user's health or level of fitness (e.g., vital signs measurements, medication information, exercise information), date of birth, or any other identifying or personal information. Specifically, as described herein, one aspect of the present disclosure is tracking an object of interest to the user in a physical environment.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording and/or sharing of personal information data or images. In addition to providing “opt in” and “opt out” options, the present disclosure contemplates providing notifications relating to the access or use of personal information. For instance, a user can be notified upon initiating collection that their personal information data will be accessed and then reminded again just before personal information data is accessed by the one or more devices.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

1. A method comprising:
at a wearable device in communication with one or more displays and one or more input devices:
while presenting, via the one or more displays, a three-dimensional environment including a second electronic device with a display, wherein the second electronic device is communicatively coupled to the wearable device:
receiving an indication that content is displayed at the display of the second electronic device; and
in accordance with a determination that the content displayed at the display of the second electronic device satisfies one or more first criteria:
presenting, via the one or more displays of the wearable device, a first set of one or more features associated with the content in a location within the three-dimensional environment different from the location of the display of the second electronic device while the second electronic device presents, at the display of the second electronic device, a second set of one or more features associated with the content, different from the first set of the one or more features associated with the content.

2. The method of claim 1, further comprising:
while presenting the first set of one or more features in the location within the three-dimensional environment different from the location of the display of the second electronic device:
detecting, via the one or more input devices, an attention of a user directed to the display of the second electronic device;
in response to detecting the attention of the user directed to the display of the second electronic device:
ceasing the presentation of the first set of one or more features at the location within the three-dimensional environment different from the location of the display of the second electronic device; and
causing the second electronic device to display the first set of one or more features at the display of the second electronic device.

3. The method of claim 1, wherein:
the second set of one or more features associated with the content includes a control user interface configured to modify one or more aspects of the content.

4. The method of claim 1, wherein the first set of one or more features associated with the content corresponds to spatial content.

5. The method of claim 1, further comprising:
detecting, via the one or more input devices, a user input corresponding to a selection of a feature of the second set of one or more features associated with the content, wherein the feature corresponds to an application associated with the second electronic device;
in response to detecting the user input:
causing the second electronic device to cease display of a subset of the second set of one or more features associated with the content at the display of the second electronic device, wherein the subset corresponds to interactable controls associated with the application; and
updating, via the one or more displays, the first set of one or more features associated with the content to include the subset of the second set of one or more features associated with the content.

6. The method of claim 1, wherein the second set of one or more features displayed at the second electronic device corresponds to a catalogue of one or more content items, the method further comprising:
in accordance with a detection of a selection of a first content item of the one or more content items, updating, via the one or more displays, the first set of one or more features associated with the content to include the first content item.

7. The method of claim 1, wherein the one or more first criteria include a first criterion that is satisfied in accordance with detecting a user input directed at the content displayed at the display of the second electronic device selecting the content to be presented in the location within the three-dimensional environment different from the location of the display of the second electronic device, and a second criterion, different than the first criterion, that is satisfied in accordance with determining that the content displayed at the display of the second electronic device selected by the user input corresponds to spatial content.

8. The method of claim 1, further comprising:
in accordance with a determination that the content displayed at the display of the second electronic device satisfies a first criterion of the one or more first criteria:
detecting, via the one or more input devices, a first user input directed at the content displayed at the display of the second electronic device;
updating, via the one or more displays, the first set of one or more features associated with the content to include the content at the location within the three-dimensional environment different from the location of the display of the second electronic device, wherein the content is displayed with one or more spatial properties; and
in accordance with a detection, via the one or more input devices, of a second user input, different than the first user input, directed at the content displayed at the location within the three-dimensional environment different from the location of the display of the second electronic device, updating, via the one or more displays, an aspect of the one or more spatial properties.

9. A wearable device, comprising:
one or more displays;
one or more input devices;
one or more processors;
memory; and
one or more programs, wherein the one or more programs are stored in the memory and configured to be executed by the one or more processors, the one or more programs including instructions for:
while presenting, via the one or more displays, a three-dimensional environment including a second electronic device with a display, wherein the second electronic device is communicatively coupled to the wearable device:
receiving an indication that content is displayed at the display of the second electronic device; and
in accordance with a determination that the content displayed at the display of the second electronic device satisfies one or more first criteria:
presenting, via the one or more displays of the wearable device, a first set of one or more features associated with the content in a location within the three-dimensional environment different from the location of the display of the second electronic device while the second electronic device presents, at the display of the second electronic device, a second set of one or more features associated with the content, different from the first set of the one or more features associated with the content.

10. The wearable device of claim 9, wherein the one or more programs further include instructions for:
while presenting the first set of one or more features in the location within the three-dimensional environment different from the location of the display of the second electronic device:
detecting, via the one or more input devices, an attention of a user directed to the display of the second electronic device;
in response to detecting the attention of the user directed to the display of the second electronic device:
ceasing the presentation of the first set of one or more features at the location within the three-dimensional environment different from the location of the display of the second electronic device; and
causing the second electronic device to display the first set of one or more features at the display of the second electronic device.

11. The wearable device of claim 9, wherein:
the second set of one or more features associated with the content includes a control user interface configured to modify one or more aspects of the content.

12. The wearable device of claim 9, wherein the first set of one or more features associated with the content corresponds to spatial content.

13. The wearable device of claim 9, wherein the one or more programs further include instructions for:
detecting, via the one or more input devices, a user input corresponding to a selection of a feature of the second set of one or more features associated with the content, wherein the feature corresponds to an application associated with the second electronic device;
in response to detecting the user input:
causing the second electronic device to cease display of a subset of the second set of one or more features associated with the content at the display of the second electronic device, wherein the subset corresponds to interactable controls associated with the application; and
updating, via the one or more displays, the first set of one or more features associated with the content to include the subset of the second set of one or more features associated with the content.

14. The wearable device of claim 9, wherein the second set of one or more features displayed at the second electronic device corresponds to a catalogue of one or more content items, the one or more programs including further instructions for:
in accordance with a detection of a selection of a first content item of the one or more content items, updating, via the one or more displays, the first set of one or more features associated with the content to include the first content item.

15. The wearable device of claim 9, wherein the one or more first criteria include a first criterion that is satisfied in accordance with detecting a user input directed at the content displayed at the display of the second electronic device selecting the content to be presented in the location within the three-dimensional environment different from the location of the display of the second electronic device, and a second criterion, different than the first criterion, that is satisfied in accordance with determining that the content displayed at the display of the second electronic device selected by the user input corresponds to spatial content.

16. The wearable device of claim 9, wherein the one or more programs further include instructions for:
in accordance with a determination that the content displayed at the display of the second electronic device satisfies a first criterion of the one or more first criteria:
detecting, via the one or more input devices, a first user input directed at the content displayed at the display of the second electronic device;
updating, via the one or more displays, the first set of one or more features associated with the content to include the content at the location within the three-dimensional environment different from the location of the display of the second electronic device, wherein the content is displayed with one or more spatial properties; and
in accordance with a detection, via the one or more input devices, of a second user input, different than the first user input, directed at the content displayed at the location within the three-dimensional environment different from the location of the display of the second electronic device, updating, via the one or more displays, an aspect of the one or more spatial properties.

17. A non-transitory computer readable storage medium storing one or more programs, the one or more programs comprising instructions, which when executed by one or more processors of a wearable device in communication with one or more displays and one or more input devices, cause the wearable device to perform:
while presenting, via the one or more displays, a three-dimensional environment including a second electronic device with a display, wherein the second electronic device is communicatively coupled to the wearable device:
receiving an indication that content is displayed at the display of the second electronic device; and
in accordance with a determination that the content displayed at the display of the second electronic device satisfies one or more first criteria:
presenting, via the one or more displays of the wearable device, a first set of one or more features associated with the content in a location within the three-dimensional environment different from the location of the display of the second electronic device while the second electronic device presents, at the display of the second electronic device, a second set of one or more features associated with the content, different from the first set of the one or more features associated with the content.

18. The non-transitory computer readable storage medium of claim 17, further storing instructions which, when executed by the one or more processors, further cause the wearable device to perform:
while presenting the first set of one or more features in the location within the three-dimensional environment different from the location of the display of the second electronic device:
detecting, via the one or more input devices, an attention of a user directed to the display of the second electronic device;
in response to detecting the attention of the user directed to the display of the second electronic device:
ceasing the presentation of the first set of one or more features at the location within the three-dimensional environment different from the location of the display of the second electronic device; and
causing the second electronic device to display the first set of one or more features at the display of the second electronic device.

19. The non-transitory computer readable storage medium of claim 17, wherein:
the second set of one or more features associated with the content includes a control user interface configured to modify one or more aspects of the content.

20. The non-transitory computer readable storage medium of claim 17, wherein the first set of one or more features associated with the content corresponds to spatial content.

21. The non-transitory computer readable storage medium of claim 17, further storing instructions which, when executed by the one or more processors, further cause the wearable device to perform:
detecting, via the one or more input devices, a user input corresponding to a selection of a feature of the second set of one or more features associated with the content, wherein the feature corresponds to an application associated with the second electronic device;
in response to detecting the user input:
causing the second electronic device to cease display of a subset of the second set of one or more features associated with the content at the display of the second electronic device, wherein the subset corresponds to interactable controls associated with the application; and
updating, via the one or more displays, the first set of one or more features associated with the content to include the subset of the second set of one or more features associated with the content.

22. The non-transitory computer readable storage medium of claim 17, wherein the second set of one or more features displayed at the second electronic device corresponds to a catalogue of one or more content items, and further storing instructions which, when executed by the one or more processors, further cause the wearable device to perform:
in accordance with a detection of a selection of a first content item of the one or more content items, updating, via the one or more displays, the first set of one or more features associated with the content to include the first content item.

23. The non-transitory computer readable storage medium of claim 17, wherein the one or more first criteria include a first criterion that is satisfied in accordance with detecting a user input directed at the content displayed at the display of the second electronic device selecting the content to be presented in the location within the three-dimensional environment different from the location of the display of the second electronic device, and a second criterion, different than the first criterion, that is satisfied in accordance with determining that the content displayed at the display of the second electronic device selected by the user input corresponds to spatial content.

24. The non-transitory computer readable storage medium of claim 17, further storing instructions which, when executed by the one or more processors, further cause the wearable device to perform:
in accordance with a determination that the content displayed at the display of the second electronic device satisfies a first criterion of the one or more first criteria:
detecting, via the one or more input devices, a first user input directed at the content displayed at the display of the second electronic device;
updating, via the one or more displays, the first set of one or more features associated with the content to include the content at the location within the three-dimensional environment different from the location of the display of the second electronic device, wherein the content is displayed with one or more spatial properties; and
in accordance with a detection, via the one or more input devices, of a second user input, different than the first user input, directed at the content displayed at the location within the three-dimensional environment different from the location of the display of the second electronic device, updating, via the one or more displays, an aspect of the one or more spatial properties.
